(19) United States
(12) Patent Application Publication
(10) Pub. No.: US 2022/0255124 A1
(43) Pub. Date: Aug. 11, 2022

(54) USE OF AN AIR-STABLE SOLID ELECTROLYTE

(71) Applicant: Volkswagen Aktiengesellschaft, Wolfsburg (DE)

(72) Inventor: Wenbo ZHANG, Calberlah (DE)

(73) Assignee: Volkswagen Aktiengesellschaft, Wolfsburg (DE)

(21) Appl. No.: 17/591,024

(22) Filed: Feb. 2, 2022

(30) Foreign Application Priority Data
Feb. 5, 2021 (DE) DE 10 2021 201 10

(51) Int. Cl. H01M 10/0562; H01M 10/0525; C01D 15/04; C01F 17/36

(52) U.S. Cl. CPC H01M 10/0562; H01M 10/0525; H01M 2300/008; C01F 17/36; C01D 15/04

(57) ABSTRACT

An air-stable solid electrolyte may be used as a coating for a battery component of a battery cell.

### CROSS REFERENCE TO RELATED APPLICATION

This application claims priority to German Patent Application No. 10 2021 201 102.0, filed Feb. 5, 2021, which is hereby incorporated by reference.

### FIELD OF THE INVENTION

The invention relates to the use of an air-stable solid electrolyte as a coating for a battery component of a battery cell. The invention also relates to a battery component and to a battery cell.

### BACKGROUND OF THE INVENTION

Motor vehicles which are driven or can be driven electrically or by an electric motor, such as electric or hybrid vehicles, generally comprise an electric motor by means of which one or both vehicle axles can be driven. To supply electrical energy, the electric motor is usually connected to a vehicle-internal (high-voltage) battery as an electrical energy store.

A battery, in particular an electrochemical battery, is to be understood here and in the following in particular as a secondary battery of the motor vehicle. In such a (secondary) vehicle battery, consumed chemical energy can be restored by means of an electrical (re)charging process. Such vehicle batteries are designed, for example, as electro-chemical accumulators, in particular as lithium-ion accumulators. In order to generate or provide a sufficiently high operating voltage, such vehicle batteries typically have at least one battery cell module in which a plurality of individual battery cells are connected in a modular manner.

The battery cells are designed, for example, as electrochemical (thin-)film cells. The thin-film cells have a layered structure having a cathode layer (cathode) and having an anode layer (anode) and having a separator layer (separator) introduced therebetween. These components are penetrated, for example, by a liquid electrolyte which produces an ionically conductive connection between the components or a charge balancing. Generally, a plurality of layer cells are stacked on top of one another as a cell stack.

Layer cells having a solid electrolyte (solid-state electrolyte: SSE), hereinafter also referred to as solid-state cells or ASSB cells (ASSB: all solid-state battery), have a higher energy storage density than layer cells having liquid electrolytes for the same weight and/or volume. Batteries having solid-state cells are also referred to below as solid-state batteries (SSB). In the case of solid-state cells, the cathode or the cathode layer is generally designed as a so-called composite cathode made from a solid-polymer composite material. Composite cathodes have, for example, cathode materials, binder materials, conductive additives (carbons) and solid electrolytes (particulate).

The solid electrolytes act as an ionically conductive additive in the composite cathode. To improve the electrical properties, the composite cathode is often mixed with conductive particles as an additional conductive additive. Due to their high conductivity, carbon-based conductive particles, such as conductive carbon black or conductive graphite, are an important component of lithium-ion batteries since they reduce the cathode resistance and thus the internal resistance of the battery.

In the case of solid-state batteries, the solid electrolyte is important for the energy density, power density and safety of the solid-state cell or battery. Due to a high ionic conductivity, solid-state cells often use sulfide solid electrolytes, i.e., solid electrolytes having a sulfide compound. Disadvantageously, however, sulfide-based solid electrolytes have low air stability. In particular, gas hydrogen sulfide (H₂S) can be the result of a chemical reaction of the sulfide solid electrolyte with atmospheric moisture. Hydrogen sulfide is a toxic, corrosive and flammable gas and can irritate the eyes, nose and throat from concentrations as low as 5 ppm (parts per million). Furthermore, lithium nickel manganese cobalt oxides (NMC), such as NMC 811, are generally used as cathode materials, and these also have a high sensitivity to, i.e., low stability in, air and (air) moisture.

In order to protect the air-sensitive components of the battery cell (battery components), cell production or manufacture of the solid-state cell is usually carried out in a dry room having a high dew point (for example −60° C.). This results in high costs for the system and its operation, as a result of which the production costs of the battery cell or solid-state cell are disadvantageously increased.

### SUMMARY OF THE INVENTION

The invention has the object of providing a particularly suitable use of an air-stable solid electrolyte. In particular, cell production of a battery cell that is as cost-reduced and cost-effective as possible should be ensured. The invention also has the object of providing a particularly suitable battery component and a particularly suitable battery cell.

According to the invention, the problem is solved in respect of the claimed method, in respect of the claimed battery component, and in respect of the claimed battery cell. Advantageous embodiments and developments are the subject matter of the dependent claims. The advantages and embodiments mentioned in respect of the use can also be transferred analogously to the battery component and/or the battery cell, and vice versa.

According to the invention, an air-stable solid electrolyte, i.e., an air-resistant or moisture-resistant solid electrolyte material, is used to coat a battery component of a battery cell. In other words, a battery component of the battery cell is coated with an air-stable solid electrolyte. As a result, an air-sensitive or moisture-sensitive battery component is provided with a suitable protective layer, and therefore it is possible to carry out assembly or production of the battery cell in a milder atmosphere. As a result, production costs are significantly reduced, and therefore a particularly suitable use is found.

“Air-stable” is to be understood here and in the following as an (electro)chemical stability of the solid electrolyte with respect to air or humidity, i.e., a thermodynamic or at least kinetic stability of the solid electrolyte in an air environment, such that the chemical composition of the solid electrolyte in air is stable at least for a certain period of time.

The air-stable solid electrolyte is preferably air-stable at least over the duration of the production process of the battery cell.

A battery component is understood here and below to mean in particular a part or constituent of the battery cell. In particular, a battery component is to be understood to mean an electrode layer, for example a cathode or composite cathode layer, of the battery cell. A battery component is also to be understood to mean the constituents of such an electrode layer, i.e., the electrode layer material. In the case of a composite cathode, the electrode layer material is designed in particular as a composite material which is produced, for example, from a cathode material and a solid electrolyte as an ionic conductive additive as well as other electrically conductive additives (carbons) and a binder, with a battery component here in particular being understood to mean a solid electrolyte and/or the cathode material and/or the conductive additive.

The conjunction “and/or” is to be understood here and in the following in such a way that the features linked by this conjunction can be formed both jointly and as alternatives to one another.

According to the invention, the surface of the relevant battery components is modified so that the stability of the battery components with respect to air and humidity is improved. For this purpose, an air-stable solid electrolyte is used as a coating material.

In a suitable embodiment, the air-stable solid electrolyte has sufficient lithium-ion conductivity so that the coating does not cause any additional charge transfer resistance of the battery component. This ensures that the battery cell can be charged quickly and reliably. The air-stable solid electrolyte suitably has an ionic conductivity of greater than 10⁻⁴ S/cm (Siemens per centimeter), in particular greater than 10⁻³ S/cm.

The air-stable solid electrolyte preferably also has electrochemical stability within the operating voltage range of the battery cell. In the case of a lithium solid-state cell, the operating voltage range is, for example, between 2.5 V (volts) and 4.3 V for Li/Li⁺. Furthermore, the air-stable solid electrolyte coating must not decompose during cycles.

The design principle of an air-stable solid electrolyte having the above properties is described, for example, in the publication “Materials Design Principles for Air-Stable Lithium/Sodium Solid Electrolytes” by Dr. Y. Zhu and Prof. Y. Mo (DOI: 10.1002/anie.202007621).

In a conceivable embodiment, the air-stable solid electrolyte is selected from a group formed by lithium-indium chloride (Li₃InCl₆), lithium-indium bromide (Li₃InBr₆), a lithium-lanthanum iodide (Li₃LaI₆), a lithium-lutetium chloride (Li₃LuCl₆), or a lithium-conducting rare-earth halide of the form Li₃MX₆, where M represents either yttrium Y, erbium Er or scandium Sc, and where X represents either chlorine Cl, bromine Br, or iodine I, or of the form Li₃₋ₓM₁₋ₓZrₓCl₆ (where x≤0.6 and where M represents either Er or Y), or of the form Li₃Y₁₋ₓInₓCl₆ (where 0≤x<1), or of the form LiₓScCl₃₊ₓ (where 0≤x≤5, in particular 1≤x≤5).

In a preferred development, the use according to the invention is used in a solid-state cell or ASSB cell. As a result of the simplified production and associated cost reduction, solid-state cells or solid-state batteries are becoming more competitive than conventional lithium-ion battery cells and thin-film cells. The use according to the invention is therefore preferably provided in particular for battery components of a solid-state cell, and is suitable and designed for this.

In an additional or further aspect of the invention, the battery component is coated before cell production of the battery cell.

For example, the solid electrolyte and/or the conductive additive and/or a cathode material of a composite cathode are coated with the air-stable solid electrolyte material before the composite cathode is produced. As a result, the components are protected from air and moisture from the start. As a result, it is not necessary for the cathode to be produced in a protective atmosphere or in a dry room having a very low dew point. This ensures particularly cost-effective cell production. In other words, the components required for cell production are coated and protected before assembly and production processes are carried out. In this case, the coating can be carried out in a protective atmosphere, for example in a glove box. Atomic layer deposition (ALD), sol-gel, or spray drying, etc., can be used as coating methods. After the coating process, it is possible to carry out the subsequent cell assembly in air having a low dew point (e.g., −10° C.), or even in a normal atmosphere.

It is also conceivable, for example, for a composite cathode to be produced having a certain porosity (for example 40%) and then for the composite cathode to be coated as a battery component. For this purpose, the porous composite cathode is coated with a solution of the air-stable solid electrolyte, for example, and is thus protected from air.

The battery component according to the invention has an outer coating having an air-stable solid electrolyte. In this case, the coating has a sufficient layer thickness to reliably protect the battery components from air and moisture. In a suitable dimensioning, the coating has a layer thickness of between 10 nm (nanometers) and 1,000 nm, for example.

The battery cell according to the invention has at least one battery component as described above. The explanations made in connection with the battery component and/or the use also apply to the battery cell, and vice versa. The battery cell is preferably a solid-state cell.

### BRIEF DESCRIPTION OF THE DRAWINGS

Embodiments of the invention are explained in more detail below with reference to the drawings, shown in schematic and simplified representations, in which:

FIG. 1 shows a solid-state battery,

FIG. 2 shows a coating of a cathode material,

FIG. 3 shows a coating of a conductive additive,

FIG. 4 shows a coating of a solid electrolyte, and

FIG. 5 shows a method for coating a composite cathode.

Corresponding parts and dimensions are always provided with the same reference signs in all figures.

### DETAILED DESCRIPTION OF THE INVENTION

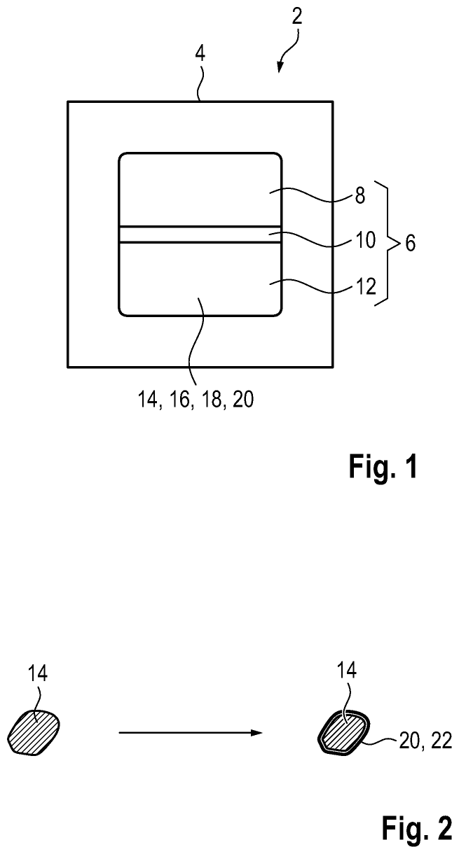

FIG. 1 shows a solid-state battery 2 for an electrically driven or drivable motor vehicle, for example an electric or hybrid vehicle. The solid-state battery 2 has a battery housing 4 and at least one battery cell 6 accommodated therein. The battery cell 6, also referred to below as a solid-state cell, has a number of battery components 8, 10, 12, 14, 16, 18. The battery component 8 is an anode layer forming the anode of the battery cell 6, the battery component 10 being a separator layer. The battery component 12 is a composite cathode of the solid-state cell 6 made of a composite material containing the battery components 14, 16 and 18.

In this case, the battery component 14 is a cathode material, the battery component 16 is a conductive additive, and the battery component 18 is a solid electrolyte as an ionic conductive additive. The battery component 12 or one or each battery component 14, 16, 18 have a low or reduced stability to air or moisture. In other words, the battery components 12, 14, 16, 18 have a comparatively high sensitivity to air or moisture.

To protect these battery components 12, 14, 16, 18, one or more of these components is coated with an air-stable solid electrolyte 20 (FIGS. 2 to 4).

FIG. 2 shows a coating of the cathode material 14. The cathode material 14 is, for example, NMC, in particular NMC 811, and in particular has a high Ni content. The coating of the active cathode material 14 with the air-stable solid electrolyte 20 protects the cathode material 14 from chemical reaction with air and allows the cathode material 14 to be handled in a normal atmosphere.

FIG. 4 shows a coating of the solid electrolyte 18. The solid electrolyte 18 is designed in particular as a sulfide solid electrolyte. The coating of the surface of the solid electrolyte 18 with an air-stable solid electrolyte 20 improves the air stability of the sulfide solid electrolyte 18 and prevents the release of hydrogen sulfide into the air.

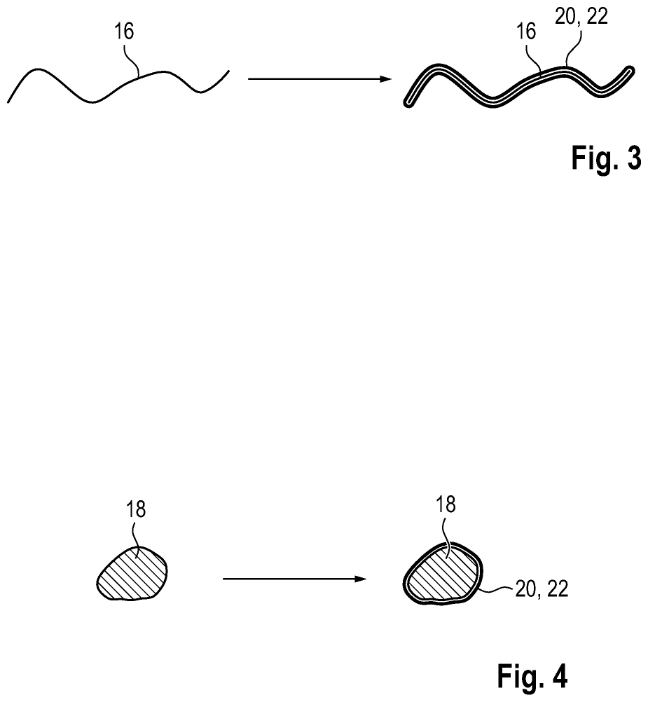

FIG. 3 shows a coating of the conductive additive 16. In this case, for example, carbon-based conductive particles, for example carbon fibers, are provided as the conductive additive 16. The coating of carbon with the air-stable solid electrolyte 20 reduces unwanted secondary reactions at the interfaces between the carbon-based conductive additive 16 and the sulfide solid electrolyte 18.

The coating(s) can be carried out in a protective atmosphere, for example in a glove box. For example, atomic layer deposition, sol-gel, or spray drying, etc., can be used as coating methods. After the coating process, it is possible to carry out the subsequent cell assembly in air having a low dew point (e.g., −10° C.), or even in a normal atmosphere. The resulting protective layer or coating is indicated by the reference sign 22 in the figures.

The air-stable solid electrolyte 20 of the coating 22 has an ionic conductivity of greater than 10⁻⁴ S/cm, in particular greater than 10⁻³ S/cm. In this case, the coating 22 has a layer thickness of between 10 nm and 1,000 nm, for example. The air-stable solid electrolyte 20 is, for example, a chloride-based solid electrolyte. In particular, the solid electrolyte 20 is a material selected from a group formed by lithium-indium chloride (Li₃InCl₆), lithium-indium bromide (Li₃InBr₆), a lithium-lanthanum iodide (Li₃LaI₆), a lithium-lutetium chloride (Li₃LuCl₆), or a lithium-conducting rare-earth halide of the form Li₃MX₆, where M represents either yttrium Y, erbium Er or scandium Sc, and where X represents either chlorine Cl, bromine Br, or iodine I, or of the form Li₃₋ₓM₁₋ₓZrₓCl₆ (where x≤0.6 and where M represents either Er or Y), or of the form Li₃Y₁₋ₓInₓCl₆ (where 0≤x<1), or of the form LiₓScCl₃₊ₓ (where 0≤x≤5, in particular 1≤x≤5).

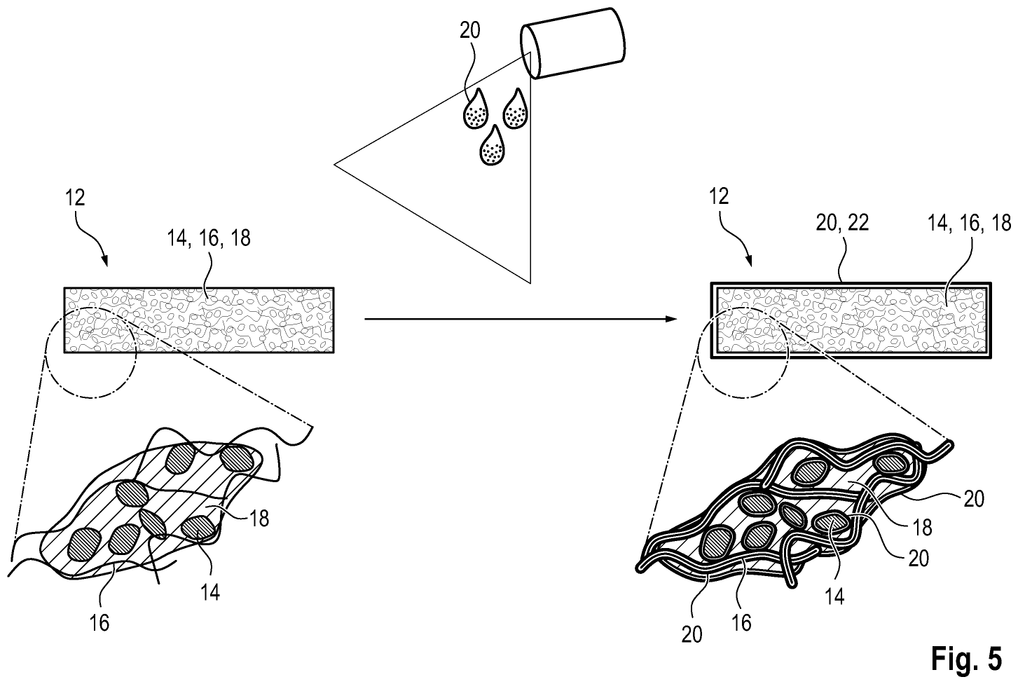

In the embodiment of FIG. 2-4, the battery components 14, 16, 18 are preferably coated before the composite cathode 12 is produced. FIG. 5 shows an alternative embodiment in which the composite cathode 12 is produced first and then coated with the solid electrolyte 20. In this case, the composite cathode has, for example, a porosity of 40% so that a solution with the solid electrolyte 20 can substantially completely penetrate or infiltrate the composite material and thus coat it.

The claimed invention is not restricted to the embodiments described above. Rather, other variants of the invention can also be derived therefrom by a person skilled in the art within the scope of the disclosed claims without departing from the subject matter of the claimed invention. In particular, all of the individual features described in connection with the different embodiments can also be combined in other ways within the scope of the disclosed claims without departing from the subject matter of the claimed invention.

### LIST OF REFERENCE SIGNS

2 Solid-state battery

4 Battery housing

6 Solid-state cell/battery cell

8 Battery component/anode layer

10 Battery component/separator layer

12 Battery component/composite cathode

14 Battery component/cathode material

16 Battery component/conductive additive

18 Battery component/solid electrolyte

20 Solid electrolyte

22 Coating

1. A coating for a battery component of a battery cell, comprising an air-stable solid electrolyte.

2. The coating according to claim 1, wherein the battery cell is a solid-state cell.

3. The coating according to claim 1, wherein the solid electrolyte has an ionic conductivity of greater than 10⁻⁴ S/cm, in particular greater than 10⁻³ S/cm.

4. The coating according to claim 1, wherein the solid electrolyte is selected from the group consisting of:
Li₃InCl₆,
Li₃InBr₆,
Li₃YX₆, where X represents Cl, Br, or I,
Li₃ErX₆, where X represents Cl, Br, or I,
Li₃ScX₆, where X represents Cl, Br, or I,
Li₃LaI₆,
Li₃LuCl₆,
Li₃₋ₓEr₁₋ₓZrₓCl₆, where x≤0.6,
Li₃₋ₓY₁₋ₓZrₓCl₆, where x≤0.6,
Li₃Y₁₋ₓInₓCl₆, where 0≤x<1, and
LiₓScCl₃₊ₓ, where 0≤x≤5.

5. The coating according to claim 1, wherein the battery component is coated before cell production of the battery cell.

6. A battery component of a battery cell, having at least one coating made of an air-stable solid electrolyte.

7. The battery component according to claim 6, wherein the coating has a layer thickness of between 10 nm and 1,000 nm.

8. A battery cell having a battery component according to claim 6.
